(19) United States
(12) Patent Application Publication
(10) Pub. No.: US 2008/0316039 A1
(43) Pub. Date: Dec. 25, 2008

(54) Apparatus and Method For Infrared Beam Smoke Detection

(76) Inventors: Mark White, Doncaster (GB); James Warren Rees, Hertfordshire (GB)

Correspondence Address: Patti Carment B;Patti Hewitt & Arezina, One N LaSalle Street, 44th Floor, Chicago, IL, 60602, US

(21) Appl. No.: 11/920,641

(22) PCT Filed: May 16, 2006
(86) PCT No.: PCT/GB2006/001799

§ 371 Date: Dec. 26, 2007

(30) Foreign Application Priority Data
May 16, 2005 (GB) 0509985.8

(51) Int. Cl. G08B 17/10

(52) U.S. Cl. 340/630

(57) ABSTRACT

Infra-red beam smoke detection apparatus comprises an infra-red transmitter or detector or both, in which the or each transmitter or detector is mounted in a housing for angular adjustment to vary the beam direction relative to a fixed axis of the housing, comprising an electrically-driven actuator for effecting the angular adjustment of the beam direction. Also, the infra-red beam transmitter has a visible light beam transmitter arranged selectively to transmit a collimated beam of visible light coaxially with the infra-red beam. A remote interface unit (RIU), for an infra-red beam smoke detection system comprising distributed infra-red transmitters and detectors, is formed to be fixed to a wall surface and to be connected to external cables for power and data transfer to and from the transmitters and detectors, and has electronic means for controlling the transmitters and detectors remotely through the external cables to ensure their optical alignment and to determine the presence of smoke so as to trigger an alarm. Also, an infra-red beam smoke detection apparatus comprises a base unit having an internal electrical wiring terminal arrangement for connection to an external electrical cable for power supply and data transfer; connectable by bayonet coupling to a head unit containing optical components and electronic circuitry and an electrical terminal arrangement connected to the electronic circuitry.

This invention relates to projected beam smoke detector technology, and in particular to improvements in component parts of infra-red beam smoke detection systems and to methods of installing and maintaining the system.

Projected beam smoke detectors are typically employed in warehouses, industrial facilities and other locations having a very large protection area and high ceilings, such environments which otherwise make point type detectors impractical on the basis of cost and detection. Optical beam smoke detectors are utilised in two main configurations: reflective and end-to-end; both systems utilise the same basic technology, namely the projection and detection of a diverging infrared (IR) beam. The presence of smoke within an area of consideration attenuates the IR beam relative to the quantity of smoke. If the received signal drops below the minimum acceptable level, the presence of fire is detected.

To identify the presence of smoke, yet remain unobtrusive to normal business operation, beam smoke detectors are positioned close to the roof, which necessitates specialist equipment, additional time, cost and a laborious alignment procedure undertaken by trained personnel. Unfortunately, in the present environment, such requirements of time, personnel and cost cannot always be fulfilled, which result in poor alignment and hence sub-optimal performance.

Due to the beam's divergent nature, alignment is of utmost importance, not only during installation, but also throughout the device's operational life. Common problems at the time of installation are aligning the beam upon a secondary object, and complete misalignment due to untrained staff.

To provide feedback to the installer, during the alignment of these devices, many manufacturers (e.g as in U.S. Pat. No. 5,751,216) of beam smoke detector products provide a measurable voltage or (light emitting diode) LED display that indicate the amount of optical power received, hence how well the device is aligned. The operator then manually, usually through the use of mechanical thumb wheels, aligns the system until the previously mentioned opto-electronic methods indicate good alignment. This methodology should be adequate in aligning such beams; however, reflections from objects in close proximity to the beam, or poor optical power beam concentrations, result in alignment degradation. To counteract some problems in alignment, some products incorporate optical alignment techniques, i.e. external mirrors with cross-hairs. Unfortunately, these methodologies are time consuming and inaccurate over large distances. Additionally, with all previously applied alignment techniques, it is necessary for the commissioning engineer to be located at the beam head, which, due to their location, results in increased costs and installation time.

A reduction in installer time, improved functionality and quality (through improved beam alignment) could result in improved reliability and customer confidence.

Collimation is required of the IR device to reduce divergence, hence to maximise optical power and thus range. The majority of prior beam smoke detectors utilise high power LED's in conjunction with collimating lenses. Previous lenses have all been attached in some way to mouldings, i.e. the lenses are manufactured separately and attached thorough clip fixing or screws to a plastic case. The method of illumination, in the majority of cases is through a standard cylindrical two-pin LED, although in one reported case, a surface mount LED was used.

There are many issues with the arrangement of the lens relative to the LED. To ensure good beam quality, the IR LED position, relative to the collimating lens, has to be controlled and repeatable throughout production. Variances in distant between the LED and collimating lens will result in power fluctuations, whereas LED-collimating lens eccentricity will result in skewed beam projection. These factors have been poorly considered in prior beam detectors, where variations in height, both through LED placement and plastic moulding movements are evident. Some manufacturing techniques have been previously applied, but compete application of DFM techniques have been overlooked.

A first invention, intended to improve beam alignment, provides infrared beam smoke detection apparatus comprising an infrared transmitter or detector or both, in which the or each transmitter or detector is mounted in a housing for angular adjustment to vary the beam direction relative to a fixed axis of the housing, comprising an electrically-driven actuator for effecting the angular adjustment of the beam direction.

Correspondingly, the invention provides a method of aligning pairs of infrared beam transmitters and detectors in an infra-red beam smoke detection system, comprising controlling electrically the beam directions using electrically-driven actuators.

The transceiver is normally positioned close to the ceiling height. As the infrared beam is outside the visible spectrum, alignment has been traditionally difficult, relying on an initial rough visual alignment followed by a computer program-driven fine adjustment. It is possible for units to be confused by stray reflections from objects other than the intended target, resulting in units that are not properly aligned and therefore not properly functioning. Even where the unit is correctly aligned at installation, it is possible through relative movements between the transceiver and the target, typically caused by normal building movement, for the alignment to become compromised. With a traditional beam smoke detector it is not possible to detect or correct this error without returning to the transceiver unit.

Accordingly, a second invention provides infrared beam smoke detection apparatus comprising an infrared beam transmitter and a visible light beam transmitter arranged selectively to transmit a collimated beam of visible light coaxially with the infrared beam.

The second invention also provides a method of aligning an infrared beam transmitter with a detector or a reflector in an infra-red beam smoke detection system in an enclosed space, comprising causing the transmitter to transmit its infra-red beam to a corresponding detector or reflector across the space, causing the same transmitter to transmit a collimated visible light beam coaxially with the infra-red beam, observing a reflection of the visible light from the detector or reflector, comparing that reflection with the known position of the axis of the infrared detector or reflector, and adjusting the alignment of the transmitter and detector or reflector to place the reflection on the axis.

Current systems make it impractical if not impossible to access the detectors once they have been installed. This is the case for a number of reasons. These detectors are normally placed in large open spaces such as the ceilings in a warehouse or industrial facilities. This normally requires special equipment for them to be installed as well as maintained because of their height from the ground. They may also be installed in an area that was accessible when they were installed but for which, since then, access has been compromised, thus making it difficult to get to the detectors. Even if installed perfectly, this does not guarantee that the detectors do not need to be set up or realigned at a later date. Influences such as building movement are enough to cause the detectors to go out of alignment over a period of time, forcing realignment. Any function that requires the detectors to be accessed is not desirable for these very reasons.

Accordingly, a third invention provides a remote interface unit (RIU) for an infrared beam smoke detection system in an enclosed space, comprising distributed infra-red transmitters and detectors, the RIU being formed to be fixed to a wall surface of the enclosed space and to be connected electrically to external cables for power and optionally data transfer to and from the transmitters and detectors, and having electronic means for controlling the transmitters and detectors remotely to ensure their optical alignment and to determine the presence of smoke so as to trigger an alarm.

The third invention also provides an infrared beam smoke detection system for an enclosed space, comprising an RIU as described above, connected by electrical cables to plural infrared transmitters and detectors fixed to walls of the space such as to project infrared beams across the space, arranged for the RIU to receive detection data from all the detectors and arranged for an operator to control each of the transmitters and detectors using the RIU, to selectively adjust their optical alignment.

This invention also provides a method of installing an infra-red beam smoke detection system in an enclosed space, having an RIU as described above, comprising operating the RIU manually to connect each new transmitter or detector electrically for central power supply and data transfer.

Further, the invention provides a method of installing or maintaining an infra-red beam smoke detection system in an enclosed space, having an RIU as described above, comprising operating the RIU manually to adjust the optical alignment of each pair of the transmitters and detectors, the transmitters and detectors having electrically-controlled angular positional adjustment means connected to the RIU by the external cable.

Further still, the invention provides a method of monitoring an infra-red beam smoke detection system in an enclosed space, having an RIU as described above, comprising downloading stored data from the RIU into a handheld remote control unit.

Infrared beam smoke detectors are usually installed to protect wide-open areas of buildings where more conventional point detectors would be inappropriate or less cost effective. Beams are normally installed at high levels, near ceilings, and are regularly in difficult positions, which require special measures to access them. It is not uncommon to use abseiling techniques, bosun's chairs, scaffolding towers, cherry pickers or very high ladders during installation, commissioning or maintenance of these products.

The purpose of the fourth invention is to facilitate these processes and to ease the assembly of the product in what can be a difficult or dangerous environment.

Accordingly, the fourth invention provides an infrared beam smoke detection apparatus comprising a base unit formed to be fixed to a mounting surface or other structure of an enclosed space, having an internal electrical wiring terminal arrangement for connection to an external electrical cable for power supply and optionally data transfer; and a head unit containing optical components and electronic circuitry and an electrical terminal arrangement connected to the electronic circuitry; the base unit and the head unit being formed for mating engagement rigidly together to form an operable device, the arrangement being such that the terminal arrangements of the head unit and the base unit interconnect for the transfer of power and optionally data once they are engaged. Correspondingly, the invention also provides a method of installing an infrared beam smoke detection system in an enclosed space, comprising securing base units on a mounting surface or structure of that space, connecting electrical cabling to those base units; then fitting respective head units to the base units, preferably removably, to form complete electro-optical transmission and detection devices communicating by infrared beams across the space; in which each head unit contains optical components and electronic circuitry and an electrical terminal arrangement connected to the electronic circuitry; the base unit and the head unit being formed for mating engagement rigidly together to form an operable device, the arrangement being such that the terminal arrangement of the head unit interconnects with corresponding terminal arrangements in the base unit for the transfer of power and optionally data once they are engaged; and the mating engagement, and preferably also disengagement, being capable of being effected with the use of only one hand and without tools.

This fourth invention provides a tool-free second fix method for the benefit of an installation engineer.

The benefits of design for manufacture (DFM) may be realised in a fifth invention, which provides an infrared beam smoke detection device comprising: a housing within which is mounted rigidly a printed circuit board, at least one collimating lens and a light funnel between the printed circuit board and the lens; and an infrared transmitter and/or detector mounted rigidly on the printed circuit board in register with the light funnel which is in register with the lens; so as to transmit or receive a collimated infrared beam through the lens and light funnel.

In order that the inventions may be better understood, preferred embodiments will now be described, by way of example only, with reference to the accompanying drawings in which:

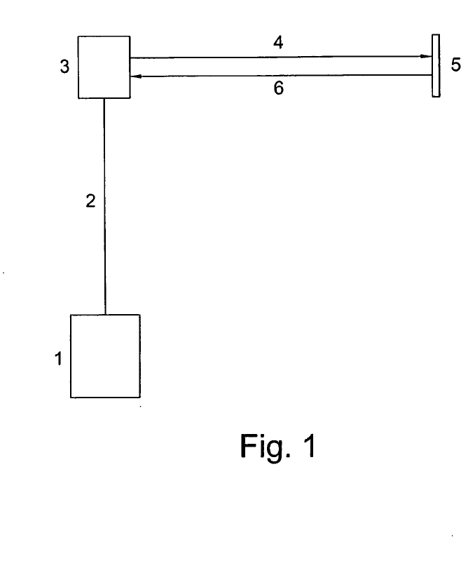

FIG. 1 is a block diagram showing the units and the connections between the units in a conventional infra-red beam smoke detection system;

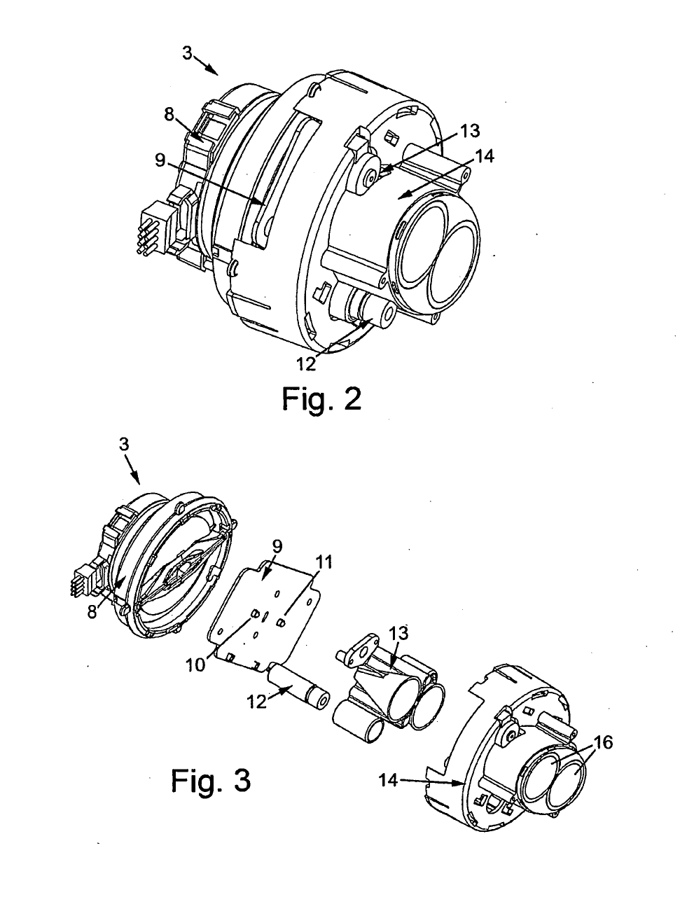

FIG. 2 is a perspective view of an assembled motorised head embodying the invention and consisting of a motor-actuated gimbals, printed circuit board comprising light emitting diodes (LED), photodiode and associated electronics, optically visible laser diode device, light funnel and lens moulding;

FIG. 3 is an exploded view of the components of the motorised head of FIG. 2, to illustrate the DFM techniques involved in this component and the assembly procedures;

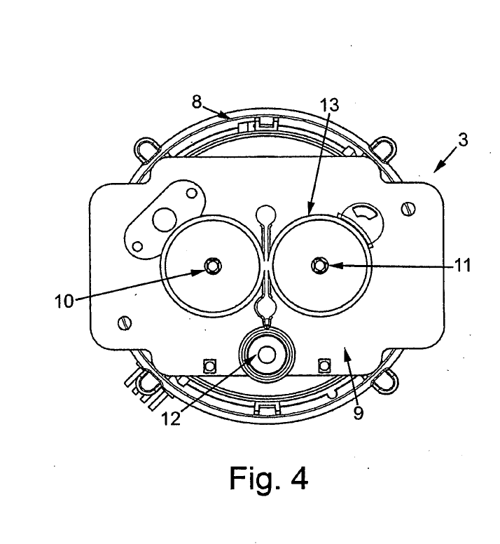

FIG. 4 is a plan view from the front of the optical arrangement of the head of FIGS. 2 and 3, without the lens moulding;

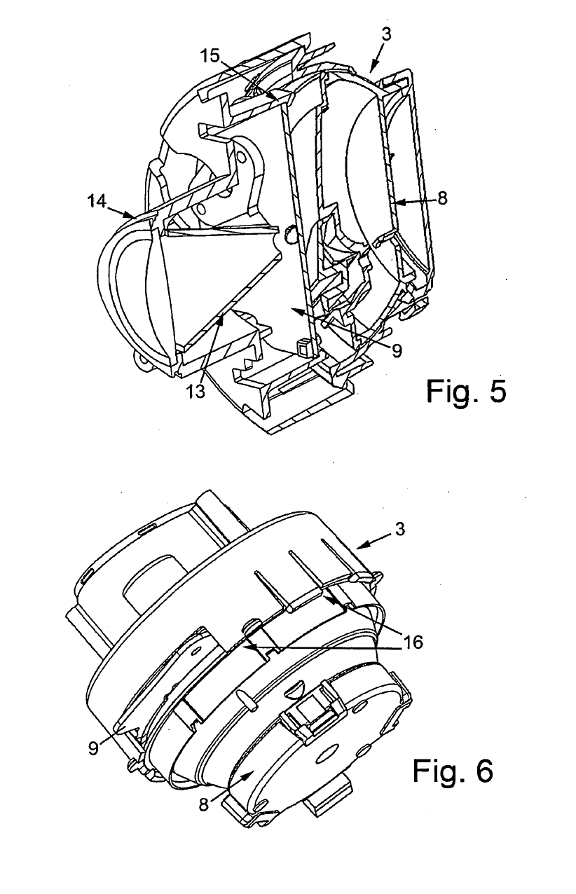

FIG. 5 is a perspective view in cross-section showing the head of FIGS. 2 to 4;

FIG. 6 is a perspective view from the side of the head of FIGS. 2 to 5;

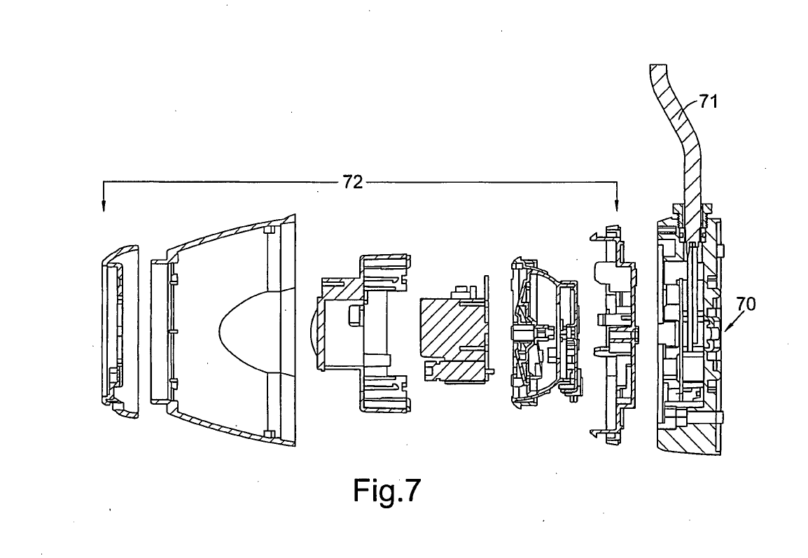

FIG. 7 is an exploded view of a complete transmitter/detector unit including a back box;

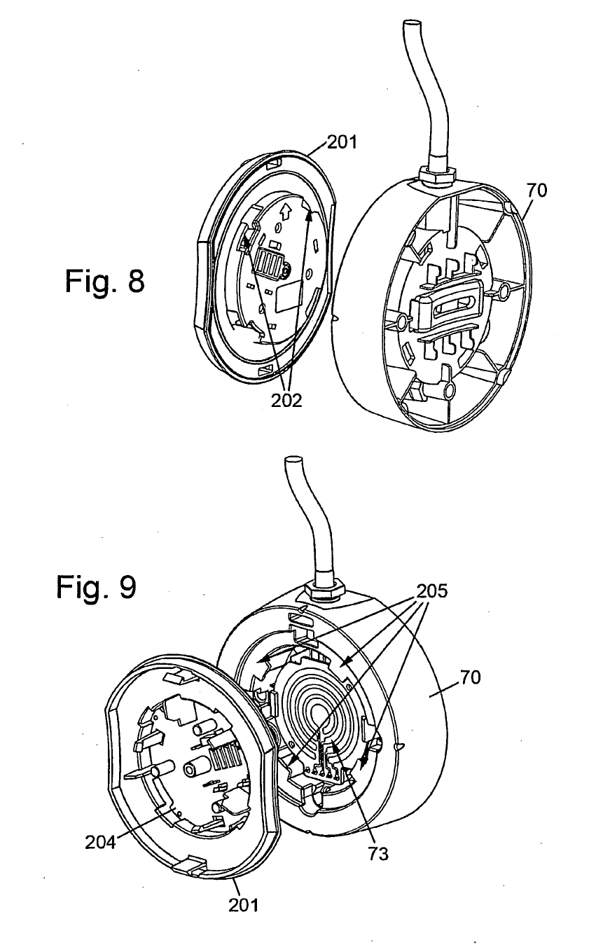

FIG. 8 is a perspective view from the rear of part of the unit of FIG. 7;

FIG. 9 is an alternative perspective view from the front of part of the unit of FIGS. 7 and 8;

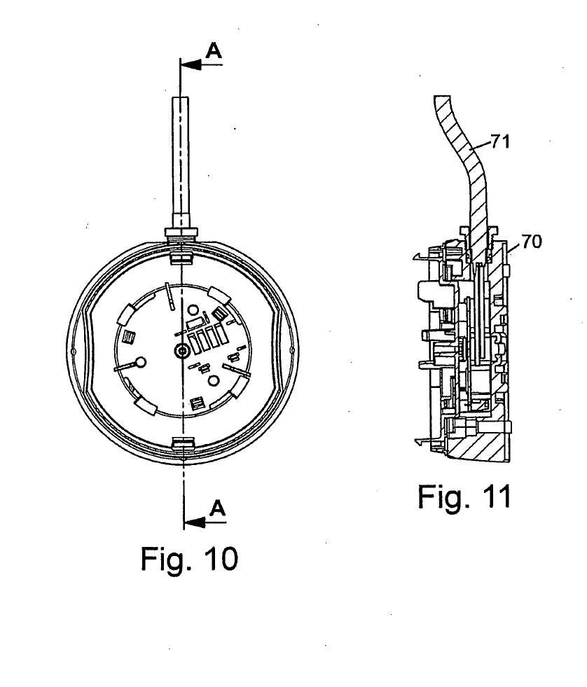

FIG. 10 is a plan view of the back box with the mating part attached of the unit of FIGS. 7 to 9;

FIG. 11 is a section through the line A-A of FIG. 10;

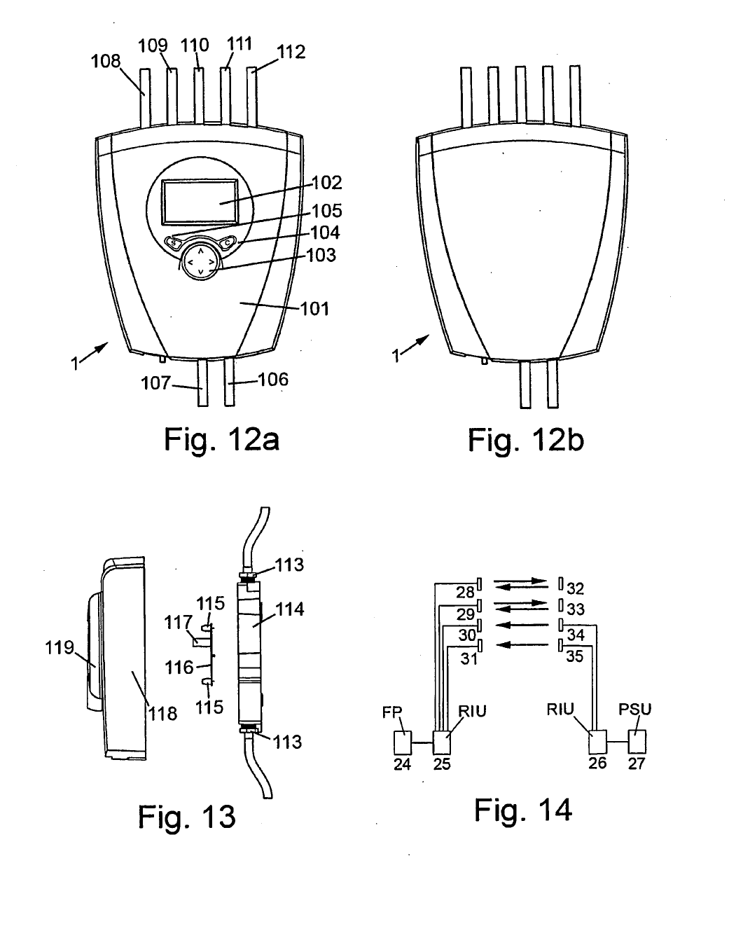

FIG. 12a is a front view of the remote interface unit (RIU) comprising a user interface installed on the controlled unit;

FIG. 12b is a front view of an RIU corresponding to FIG. 12a, but without the user interface, for use with a remote hand-held control unit;

FIG. 13 is exploded side view of the RIU of FIG. 12a, with the user interface installed;

FIG. 14 is a schematic block diagram of an infra-red beam smoke detection system;

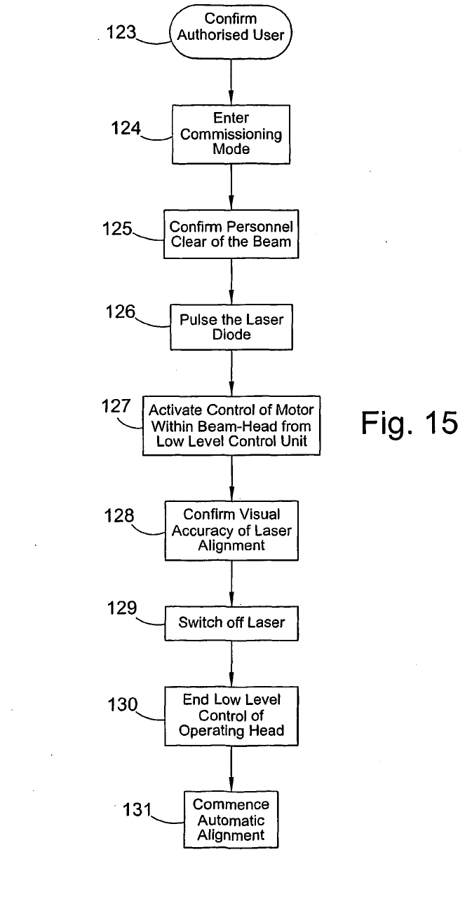

FIG. 15 is a flow chart showing the processes for commissioning a beam between transceiver devices, in the system of FIG. 14;

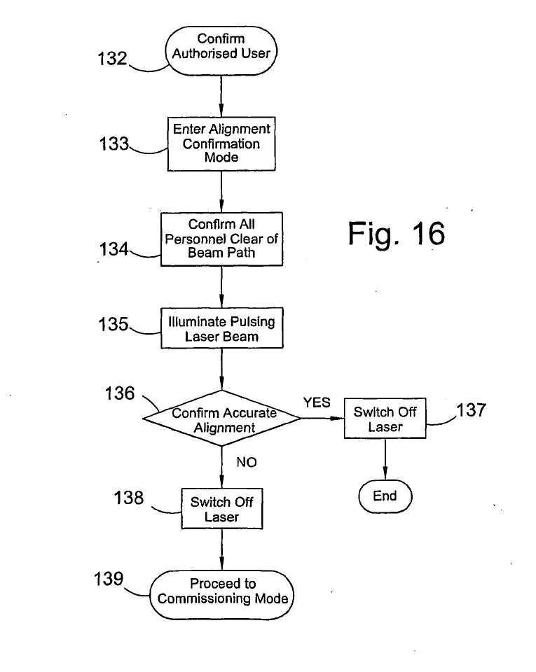

FIG. 16 is a flow chart showing the processes for confirmation of the positioning of the beam after commissioning;

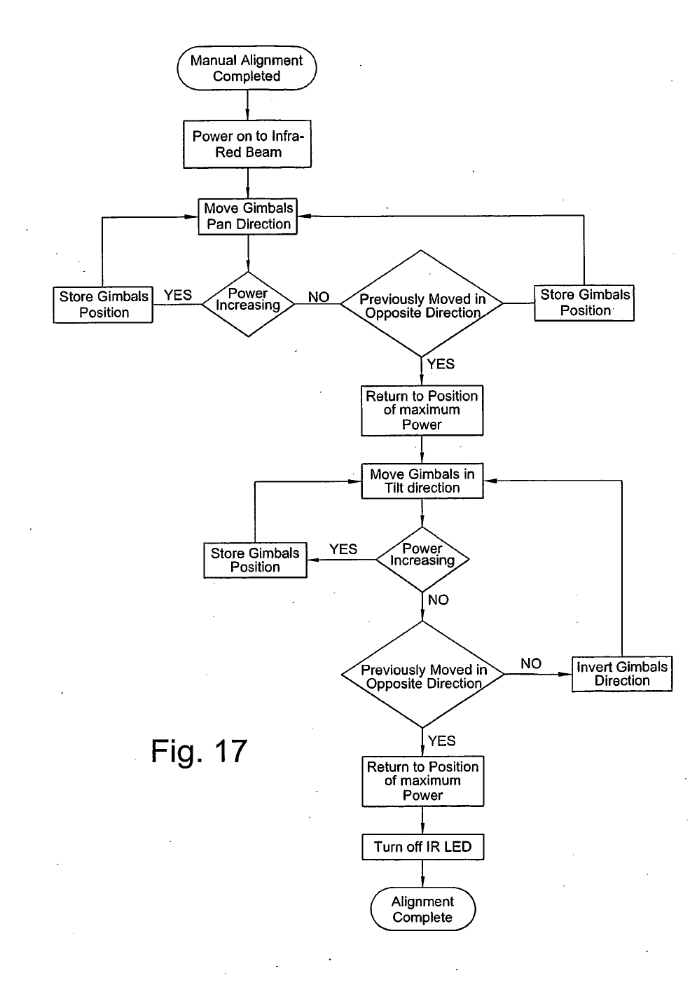

FIG. 17 is a flow chart showing the processes for automatic alignment of the beam head based upon the detection of maximum optical power in the infra-red beam;

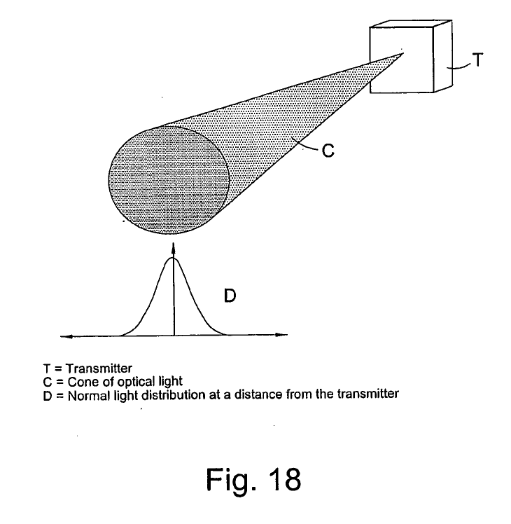

FIG. 18 is a schematic diagram illustrating the light beam used for alignment in the system of FIGS. 2 to 17.

Referring to FIG. 1, the relative positions and connections of the various units can be seen. The operator interacts with a low level controller or RIU (Remote Interface Unit) 1. This is connected via cable 2 to a remote operating head 3, typically situated at high level in an enclosed space. In normal operation, the operating head emits an infrared beam 4 to a target 5 situated some distance away. The target can either be a receiver that interprets the signal or a reflector that reflects the beam 6 back to a receiver situated within the operating head.

A motorised transceiver head is shown in FIGS. 2 to 6. The assembled motorised head of FIG. 2 includes an Eaton 300 motor-actuated gimbals 8, a PCB 9 on which an LED, photodiode and associated electronic circuitry are mounted, a cylindrical optically visible laser diode device 12, light funnel 13, and a lens moulding 14. The infrared LED produces a collimated visible beam as shown in FIG. 18. As illustrated in FIG. 3, design for manufacture (DFM) techniques are involved in these components and assembly procedures for the Eaton 300 motor, the PCB, the infrared, the light funnel and the lens moulding.

As shown in FIG. 4, the photodiode 10 for detecting infrared, LED 11 for emitting infrared, and laser diode 12 are arranged relative to one another and in conjunction with the gimbals 8, PCB 9 and light funnel 13. There is some eccentricity between the laser diode 12, transmitter 11 and receiver 10.

The positioning of the LED 11 relative to a pair of collimating lenses 16 is critical to ensure both good optical power, through locating the LED at the focal distance from its collimating lens; and to ensure overall beam quality, through making the projected light normally incident upon the collimating lens. The lenses 16 are part of the lens moulding 14 forming part of the overall housing including the gimbals 8.

To ensure that these requirements are accomplished, while employing DFM techniques, two areas of consideration are critical: LED distance from the collimating lens and location upon the PCB.

A single moulding 13 incorporates parallel light funnels of conical shape for respective infrared devices 10, 11, and a cylindrical guide for the laser diode module 12.

FIGS. 5 and 6 respectively present a section and three-dimensional view of how the PCB, lens moulding 14 and gimbals 8 are connected. This shows how the lens support, the motorised gimbals and the PCB, hence the LED and photodiode, are secured to provide minimal movement in any axis. Snap fixings 15 are the preferred method of securing parts in manufacturing due to reduced assembly time, personnel, and external fixings; avoiding increased costs.

The lens moulding 14, shown in FIG. 5, supports the PCB, which carries the LED and photodiode between a snap fixing and the lens moulding. Such an arrangement facilitates a simple push fit, but due to the rigidity of the plastics and the alignment tolerance, it secures the PCB with sub-millimetre tolerance. The snap fixing of the lens moulding and the gimbals is also shown in section. In addition, moulding the lens and support as one object decreases any possible variance between the lens and the LED, while the lens moulding is secured to the PCB.

With reference to FIG. 6, the lens moulding, and thus the PCB, is secured to the gimbals by snap fixings 16. These facilitate accurate movement of the assembly head, in accordance with the gimbals movement, while providing minimal unintentional movement, which would be observed if such advanced manufacturing techniques were not employed.

To minimise LED eccentricity and the possible occurrence of incorrect light propagation, which could be a consequence of a two-pin LED being placed at an incline, surface mount technology is used to reduce these issues. The application of surface mount LED's has two benefits in respect to relative collimating lens positioning. Firstly, datums (markers) can be placed upon the PCB which modern surface mount technology can utilise to ensure extremely accurate LED placement, thus ensuring that eccentricity relative to the collimating lens is minimised. A surface mount LED also minimises positional displacement normal to the PCB, as this is reduced to the repeatable thickness of solder flow. The angle of incline in the piece will also be minimised through this procedure.

The employment of both surface mount technology and DFM techniques in the support and fixing of the PCB minimises all LED movement relative to the position of the collimating lens (lens moulding), throughout production and product lifetime.

As the minimisation of LED-collimating lens variance is based on modern manufacturing techniques, there are numerous methods in which this aim can be achieved:

1) Securing a standard two-pin diode in place with adhesive or flush to the PCB.
2) Fixing a light guide, which terminates with the collimating lens, over the LED. This provides a known and repeatable LED-collimating lens displacement.
3) Permanently fixing, through adhesive, screws, or other mechanical and chemical methods the lens, PCB, support and motorised drive in any way so to provide invariable stack length.

FIGS. 7 to 11 illustrate how the head of the transmitter/receiver device is assembled to a back box 70 which is connected to an external electrical cable 71.

The product comprises two major parts: a back box 70 into which the external electrical connections are made and a head assembly 72 which contains all the electronic and optical components.

The back box 70 can be installed in any one of four quadrants providing flexibility in external cable routing and the head assembly 72 can be installed in its correct orientation irrespective of the orientation of the back box. In addition to the cable connectors, the back box includes the facility to accommodate a snap fit printed circuit board 73, which then provides the electrical connection between the head assembly and the back box.

First fix operation involves fixing the back box to a solid surface, connecting external cables to the designated connector and snapping in the PCB 73.

Second fix is completed by offering the head assembly 72 to the back box, rotating the head, and connecting the two by the bayonet fitting. This operation completes both the electrical and mechanical connection of the back box to the head assembly.

The bayonet coupling makes the second fix operation one-handed, being quicker and safer for the engineer and the building users and eliminates the need to use tools in a much-simplified process. The design combines the solution to achieving electrical contact and sound mechanical fit between the two keys parts of the product in one simple operation.

A rear cover 201 of detector module 72 has four mating lugs 202, which interface with bayonet lugs 205 on the ‘first fix’ back box 70. The lugs 202 have bumps 204 which, when in position, locate into grooves in the lugs 205 of the back box.

Referring to FIG. 12a, the RIU can be interfaced with up to four detectors via the interface cables 108, 109, 110 and 111. The user interface consists of a LCD 102 for visual feedback, a Set switch 105, Clear switch 104 and a gimbals switch 103. The gimbals switch 103 consists of four switches. This switch effects up, down, left and right motion. The detectors that have motorised gimbals and require steering benefit from the gimbals switch 103 as it acts as a joystick, allowing the detector or part thereof to be steered in both the x-axis and y-axis. For functions or menus that have more than one option, the gimbals switch 3 allows the user to scroll through the different options, using the up, down or left, right position. Set or Clear options are done using the Set switch 105 or Clear switch 104.

Cables 106 and 112 give the option to power the unit from an external power supply. Only one cable will be used: if the preferred method of entry is from the top then cable 112 will be used, and if bottom entry is preferred then cable 106 will be used. Cable 107 is the interface between the fire panel and the RIU; any communication between the two will be done using this cable, and in certain configurations supply power as well.

If there is no user interface, as in the alternative RIU shown in FIG. 12b, then the user interface will be provided via a remote diagnostics unit, preferably hand-held, that interfaces to the RIU via the diagnostics port. The RIU will still provide the same functions as that with the user interface (FIG. 12a) on the RIU, but any user intervention or feedback from the RIU will require the remote diagnostics unit.

Referring to FIG. 13, the side view shows the base unit 114 and the control unit 118 of the RIU. To prevent any water or moisture entering through where the cables enter the base unit 114 cable glands 113 are placed around each cable. These also act as a strain relief preventing any unnecessary strain on the terminal connectors 115 where the cables are terminated on the base unit PCB 116. With the base unit securely mounted on a wall or other support structure the control unit 118 can be interfaced to the base unit 114. Connector 117 provides the interface between the two. The control unit 118 houses most of the electronics required to monitor and communicate to the detectors and fire panel; the rest is on the base unit PCB 116. The user interface 119 is displayed in FIG. 13, but as mentioned earlier it can be omitted.

FIG. 14 is a block diagram of a typical system configuration. The fire panel 24 interfaces to the RIU 25 and it interfaces to four detectors 28, 29, 30 and 31. A second RIU 26 interfaces to a Power Supply Unit 27 and to two detectors 34 and 35.

Detector 28 is set up as a transceiver, configured in reflective mode, using a reflector 32. It transmits an infrared beam that will be reflected by reflector 32 and then received by a detector in the same device 28. Detector 29 and reflector 33 are identical to detector 28 and reflector 32.

Detectors 30 and 34 are configured in an end-to-end mode. The transmitter 34 transmits an infrared beam that will be received by detector 30. Detectors 31 and 35 are configured in the same way.

This is an example of only one set up. There are of course many more ways that a system can be configured.

When the system has been powered up, it recognises a new detector and installs it so as to communicate data and supply power from the RIU. This is usually done under operator manual control.

There are other alternative ways of remotely accessing the detectors. This could be achieved by using either RF (Radio Frequency) or IR (InfraRed), in which case cables would not be required from the RIU, but separate power supplies would be required.

With technology available such as Bluetooth or WiFi, both RF communication protocols, it would be relatively easy to interface the detectors wirelessly with the RIU. It would even be possible with this type of technology to interface the detectors directly to a portable device such as a pocket PC or Laptop that has this wireless technology built in. The same is true with optical technology such as IrDA (Infrared Data).

FIG. 15 shows a flowchart of operations for initialising the beam. At all stages the system utilises the LCD screen and associated controls on the low level controller RIU. The system requires the operator to confirm he is an authorised user 123 by means of a physical device and/or password entry. On first entering the system the unit automatically defaults to commissioning mode 124. For safety purposes, the system displays a message, asking if it is safe to illuminate the laser 125. Once confirmation is received the laser in the operating head is activated 126, sending a pulse of light that can be clearly seen by the operator, when it reflects from a reflector or a detection device. The operator can compare visually its position with the known axis of device.

The operator has control of the motor within the operating head and by utilising the controls on the low level controller can move the laser light 127. Once the operator is happy that the laser beam is pointing at the desired target he conforms this 128 and the system switches off the laser 129 and removes control of the motor in the operating head from the low level controller 130. The system then commences to go through an automatic fine-tuning of alignment using the infrared emitter.

FIG. 16 shows a flowchart of operation for checking the alignment of the beam. An operator can approach the low level controller RIU at any time after it has been commissioned to gain visual confirmation that the unit is still in alignment. The system requires the operator to confirm he is an authorised user 132 by means of a physical device and/or a password. The operator can then use the keys and LCD screen to select confirmation mode 133. For safety purposes, the system displays a message, asking if it is safe to illuminate the laser 134. Once confirmation is received the laser is pulsed to produce a visual confirmation of the current alignment 135. The operator is prompted whether the visual confirmation is on the required target 136. If the user is happy he accepts the current alignment, the laser is extinguished 137 and the operator is returned to base menu. If the operator is not happy the beam is extinguished 138 and the unit enters commissioning mode as outlined in FIG. 15.

The generalised alignment procedure of the beam head consists of a remote manual alignment and a self-aligning protocol of the head. There are two possible operational modes of the beam system, i.e. reflective and end-to-end; however, each methodology locates maximum power using feedback as detailed in FIG. 17.

Initially, the base plates are installed and roughly aligned by the installer, and once complete the heads are attached—this facilitates full alignment and commissioning. Alignment is undertaken first. Once manual alignment is initialised (FIG. 16), a laser diode in the beam-head is activated. The laser diode is connected to the PCB and hence to the Eaton 300 motor. From the ground level base unit the installer is able to view the projected beam, and hence steering the beam to the intended target through intuitive controls. Once manual alignment is achieved, power to the laser diode is removed and confirmation given that signifies the system can commence automatic alignment utilising the IR beam.

Automatic alignment concerns small incremental gimbals, and hence beam head, movements in the pan and tilt directions to achieve maximal received power. Once the position of maximum power is achieved, the system is regarded as aligned.

Manual alignment commences once the base plates are installed and the heads attached. As the smoke detection beam is infrared, hence invisible, a laser diode-operating in the visible range has to be employed to facilitate manual alignment. In reference to FIG. 16, which presents a generalised flow chart concerning alignment, manual alignment is initiated through commands given by the installer. On receipt of such commands, the laser diode is activated to provide a visual representation of the IR beam's direction. When the laser diode becomes operational, the installer proceeds with aligning the projected laser light upon the target through activation of intuitive base unit inputs that represent gimbals movement. Once the laser is projected upon the target, manual alignment is complete. Upon user confirmation of completion, power to the laser diode is discontinued and automatic alignment is initiated.

As evident from FIG. 4, the laser diode 12 is positioned in close proximity to the LED 11 to provide a good representation of the actual projected IR beam direction.

However, there will be some inaccuracy due to LED-laser diode eccentricity, the projected shape of the laser diode, and the position from which the installer views the visible beam, i.e. from a ground level perspective. To correct such minor misalignments, the automatic procedure is initiated upon completion of manual alignment.

Entering into the automatic alignment protocol, the system attempts to logically vary the gimbals' pan and tilt directions to determine the location of maximum optical power. The method and sequence of movement is dependant upon the mode of operation (reflective or end-to-end); however, the underlying operational methodology is similar. Upon automatic alignment initialisation, the system commences at a position with no prior knowledge concerning maximum optical power location and thus must rely on manual alignment providing an adequate start position.

With reference to FIG. 17, the gimbals will initially move in the pan axis, as it does so variations in the recorded optical power are detected. Based projected light distribution over a distance, a maximum will be located once increases in received power with respect to position discontinue. Accordingly, movement away from the maximum results in decreasing power. A reduction in detected power either implies incorrect direction, or, if previously rotated in the opposite direction, the maximum power had previously been located. Movement in the pan direction will continue until the maximum in this direction is located. Once located, the same power location methodology, as described previously, will be applied to the tilt direction.

A situation where no optical power is detected during automatic alignment is avoided through the application of the previously defined manual alignment procedures and divergence of the optical beam that results in a large area of IR illumination. Once a maximum is determined after both pan and tilt directions have been examined, the location of the motorised gimbal will be recorded in addition to the maximum power for reference for determining signal degradation over time and realignment.

If no maximum is located or no optical power is detected, this is a consequence of poor manual alignment. The system prompts the commissioning engineer to again manually align the head.

Within the many industrial sectors there are many areas where motion has been automated, however, for this application, the movement is novel in that a pitch-tilt device is utilised. This does not imply that only a pitch-tilt device could be employed to facilitate alignment of the optical head upon a target. Other potential, if more operationally complex, methods are:

1) X-Y positioning system employing stepper motors or DC motors for each of axis.
2) A drive system employing a singular motor where motor rotational direction is assigned to each axis of linear movement.
3) Application of linear actuators to create two-dimensional movement.
4) IR beam steering through the application of moveable reflective devices within or external to the beam head.
5) Beam steering trough mechanical movement of optical fibres.
6) Utilisation of planar mechanical linkages to transform rotation or restricted linear movement into linear movement governing the beam projection direction.

1. Infrared beam smoke detection apparatus comprising an infrared transmitter or detector or both, in which the or each transmitter or detector is mounted in a housing for angular adjustment to vary the beam direction relative to a fixed axis of the housing, comprising an electrically-driven actuator for effecting the angular adjustment of the beam direction.

2. Apparatus according to claim 1, in which the actuator comprises a gimbals which mounts the transmitter or detector in the housing.

3. Apparatus according to claim 1, configured for the angular adjustment to be controlled remotely by signals on an electric cable connected to the actuator.

4. A method of aligning pairs of infrared beam transmitters and detectors in an infra-red beam smoke detection system, comprising controlling electrically the beam directions using electrically-driven actuators.

5. A method according to claim 4, in which each transmitter or detector is mounted in a housing for angular adjustment to vary the beam direction relative to a fixed axis of the housing.

6. A method according to claim 4, in which the actuator comprises a gimbals which mounts the transmitter or detector in the housing.

7. A method according to claim 4, in which the system comprises a remote interface unit (RIU) connected by external electrical cables to units housing the respective infra-red beam transmitters and detectors and having an electronic control circuit arranged to align the transmitter and detector of each pair by effecting the angular adjustment in response to feedback from the detector indicative of optical signal strength.

8. Infrared beam smoke detection apparatus comprising an infrared beam transmitter and a visible light beam transmitter arranged selectively to transmit a collimated beam of visible light coaxially with the infrared beam.

9. Apparatus according to claim 8, in which the visible light beam transmitter comprises a laser.

10. Apparatus according to claim 9, in which the laser is capable of pulsed operation.

11. Infrared beam smoke detection apparatus comprising an infrared beam transmitter and a visible light beam transmitter arranged selectively to transmit a collimated beam of visible light coaxially with the infrared beam, in which the infrared beam transmitter is mounted in a housing for angular adjustment to vary the beam direction relative to a fixed axis of the housing, comprising an electrically-driven actuator for effecting the angular adjustment of the beam direction.

12. A method of aligning an infrared beam transmitter with a detector or a reflector in an infra-red beam smoke detection system in an enclosed space, comprising causing the transmitter to transmit its infra-red beam to a corresponding detector or reflector across the space, causing the same transmitter to transmit a collimated visible light beam coaxially with the infra-red beam, observing a reflection of the visible light from the detector or reflector, comparing that reflection with the known position of the axis of the infrared detector or reflector, and adjusting the alignment of the transmitter and detector or reflector to place the reflection on the axis.

13. A method according to claim 12, in which the adjustment of the alignment is done by electrical actuation of a connection between the detector and/or the transmitter and a corresponding housing fixed to a wall of the space.

14. A method according to claim 12, in which the adjustment of the alignment is controlled remotely of the infrared transmitter and detector or reflector by manual operator control.

15. A method according to claim 12, in which the visible light beam transmitter comprises a laser.

16. A method according to claim 15, in which the laser is pulsed.

17. A method according to claim 12, in which at least one infrared transmitter and infrared detector are housed together and are disposed opposite a reflector to cause an infrared beam to travel from the transmitter across the space to the reflector and back to the detector, comprising adjusting at least one of the transmitter and the detector to align the beam.

18. A remote interface unit, RIU, for an infrared beam smoke detection system in an enclosed space, comprising distributed infra-red transmitters and detectors, the RIU being formed to be fixed to a wall surface of the enclosed space and to be connected electrically to external cables for power and optionally data transfer to and from the transmitters and detectors, and having electronic means for controlling the transmitters and detectors remotely to ensure their optical alignment and to determine the presence of smoke so as to trigger an alarm.

19. An RIU according to claim 18, formed to be connected electrically by cable to a fire panel which is arranged to trigger a fire alarm and provide an indication of the location of the fire.

20. An RIU according to claim 18, comprising an integrated user interface with electrical switches and a visual display.

21. An RIU according to claim 18, comprising a remote control unit for operator control of the RIU, arranged to communicate locally with the RIU.

22. An RIU according to claim 21, in which the remote control unit is arranged to communicate by radio with the RIU.

23. An RIU according to claim 21, in which the remote control unit is arranged to communicate optically with the RIU.

24. An infrared beam smoke detection system for an enclosed space, comprising an RIU according to claim 18, connected by electrical cables to plural infrared transmitters and detectors fixed to walls of the space such as to project infrared beams across the space, arranged for the RIU to receive detection data from all the detectors and arranged for an operator to control each of the transmitters and detectors using the RIU, to selectively adjust their optical alignment.

25. A system according to claim 24, arranged to supply power from the RIU to all the transmitters and detectors.

26. A system according to claim 24, in which at least one pair of the transmitters and detectors are housed in a single unit and aligned with a remote reflector to cause an infrared beam to travel from that unit across the space to the reflector and back to that unit.

27. A system according to claim 24, comprising a fire panel connected by electrical cable to the RIU.

28. A system according to claim 24, in which each infrared transmitter and detector is mounted in a housing for angular adjustment to vary the beam direction relative to a fixed axis of the housing, comprising an electrically-driven actuator for effecting the angular adjustment of the beam direction, and comprising a visible light beam transmitter arranged selectively to transmit a collimated beam of visible light coaxially with the infrared beam from each infrared transmitter.

29. A system according to claim 24, in which the RIU comprises a base and a head which inter-engage electrically and mechanically to provide a sealed unit, the base having electrical connectors for external cables, and the head having electronic control circuitry.

30. A system according to claim 24, in which the RIU comprises a memory for the data it receives in use relating to its control operation and/or to detection events and/or to optical alignments.

31. A system according to claim 30, in which the RIU is configured to enable the stored data to be downloaded to an external diagnostics unit.

32. A method of installing an infra-red beam smoke detection system in an enclosed space, having an RIU according to claim 18, comprising operating the RIU manually to connect each new transmitter or detector electrically for central power supply and data transfer.

33. A method of installing or maintaining an infra-red beam smoke detection system in an enclosed space, having an RIU according to claim 18, comprising operating the RIU manually to adjust the optical alignment of each pair of the transmitters and detectors, the transmitters and detectors having electrically-controlled angular positional adjustment means connected to the RIU by the external cable.

34. A method of monitoring an infra-red beam smoke detection system in an enclosed space, having an RIU according to claim 31, comprising downloading stored data from the RIU into a handheld remote control unit.

35. An infrared beam smoke detection apparatus comprising: a base unit formed to be fixed to a mounting surface or other structure of an enclosed space, having an internal electrical wiring terminal arrangement for connection to an external electrical cable for power supply and optionally data transfer; and a head unit containing optical components and electronic circuitry and an electrical terminal arrangement connected to the electronic circuitry; the base unit and the head unit being formed for mating engagement rigidly together to form an operable device, the arrangement being such that the terminal arrangements of the head unit and the base unit interconnect for the transfer of power and optionally data once they are engaged.

36. Apparatus according to claim 35, comprising a bayonet coupling between peripheral formations on the base unit and the head unit, to allow one-handed connection and disconnection of the head unit.

37. Apparatus according to claim 35, in which the base unit has a printed circuit board connected to the external electrical cable and arranged to make electrical contact with the electrical terminal arrangement in the head when the head and the base units are fully engaged.

38. Apparatus according to claim 37, in which the printed circuit board is a push-fit in the base unit.

39. Apparatus according to claim 35, in which the head unit comprises an optical component for transmitting an infrared beam.

40. Apparatus according to claim 35, in which the head unit comprises an optical component for detecting an infrared beam.

41. A method of installing an infrared beam smoke detection system in an enclosed space, comprising securing base units on a mounting surface or other structure of that space, connecting electrical cabling to those base units;
then fitting respective head units to the base units, to form complete electro-optical transmission and detection devices communicating by infrared beams across the space;
in which each head unit contains optical components and electronic circuitry and an electrical terminal arrangement connected to the electronic circuitry;
the base unit and the head unit being formed for mating engagement rigidly together to form an operable device, the arrangement being such that the terminal arrangement of the head unit interconnects with corresponding terminal arrangements in the base unit for the transfer of power and optionally data once they are engaged;
and the mating engagement being capable of being effected with the use of only one hand and without tools.

42. A method according to claim 41, in which the mating engagement is by way of a bayonet coupling.

43. An infrared beam smoke detection device comprising:
a housing within which is mounted rigidly a printed circuit board, at least one collimating lens and a light funnel between the printed circuit board and the lens;
and an infrared transmitter and/or detector mounted rigidly on the printed circuit board in register with the light funnel which is in register with the lens; so as to transmit or receive a collimated infrared beam through the lens and light funnel.

44. A device according to claim 43, comprising a pair of light funnels parallel and adjacent to each other, between respectively an infrared transmitter on the printed circuit board and a first collimating lens, and an infrared detector on the printed circuit board and a second collimating lens.

45. A device according to claim 43, in which the lens or lenses are mounted rigidly in a moulding which surrounds the light funnel and forms part of the housing.

46. A device according to claim 43, comprising a visible light beam transmitter mounted on the printed circuit board and extending through part of the light funnel within the housing.
